(19) United States
(12) Patent Application Publication
(10) Pub. No.: US 2025/0210013 A1
(43) Pub. Date: Jun. 26, 2025

(54) Structure of a Percussion Musical Instrument, Such as a Drum and the Like, and Method of Making Said Structure of a Percussion Musical Instrument

(71) Applicant: Giorgio Capovilla, San Zenone Degli Ezzelini (TV) (IT)

(72) Inventors: Giorgio Capovilla, San Zenone Degli Ezzelini (IT); Roberts Colbertaldo, Pieve Del Grappa (IT)

(21) Appl. No.: 18/848,424

(22) PCT Filed: Apr. 5, 2023
(86) PCT No.: PCT/IB2023/053460

§ 371 Date: Sep. 18, 2024

(30) Foreign Application Priority Data
Apr. 6, 2022 (IT) 102022000006812

(51) Int. Cl. G10D 13/02

(52) U.S. Cl. CPC G10D 13/02

(57) ABSTRACT

A structure of a percussion musical instrument, such as a drum and the like, includes: a tubular shell having a main axis of symmetry (X); at least one membrane, the membrane being attached to a perimeter bearing hoop; a tensioning hoop for the at least one membrane, configured to be arranged above the bearing hoop and to be constrained to the tubular shell; a fastener and tensioner configured to constrain the tensioning hoop to the tubular shell in a direction substantially parallel to the main axis (X) of the tubular shell. The tubular shell can be a single body made of thermoplastic polymeric material.

### BACKGROUND OF THE DISCLOSURE

### 1. The Field of the Disclosure

The invention relates to a structure of a percussion musical instrument, such as a drum and the like.

Furthermore, the invention relates to a method of making the aforesaid structure of a percussion musical instrument.

### 2. The Relevant Technology

A drum is a percussion instrument.

A drum generally comprises:
a shell, usually made of wood or metal;
one or two heads, i.e., at least one batter head and possibly a second resonant head, where such heads may be natural or synthetic, each head being attached to a perimeter bearing hoop;
a tensioning hoop for each head, also made of metal or wood, configured to be arranged above the bearing hoop and to be attached to the shell;
fastening and tensioning means, configured to pull a corresponding tensioning hoop in a direction substantially parallel to the main axis of the shell, so as to pull in turn the head-bearing hoop and adjust the tension of the head itself.

Such fastening and tensioning means generally comprise a metal lug attached to the shell by threaded connections.

Such threaded connections comprise one or two radial screws, i.e., arranged radially with respect to the main axis of the shell and placed so as to pass through the shell itself, on which corresponding radial through-holes are made.

A thread for a corresponding screw tension rod is defined on each metal lug.

Each screw tension rod passes through a corresponding fin of the tensioning hoop and is screwed to the metal lug.

Depending on the size of the drum, ranging from large bass drums to small toms and the classic snare drum, the drum shell and the corresponding hoops can be configured with six, eight, or twelve sets or pairs of tension rods and fins.

Such percussion musical instruments, while being well known and appreciated, comprise a shell which is usually made of metal material or wood material, both widely used in the field and capable of cooperating to emit sonorities that are also well known, or made of a plastic material such as plexiglass, especially transparent plexiglass.

### SUMMARY OF THE DISCLOSURE

In all of the above-mentioned cases, the head-fastening and tensioning means comprise lugs screwed to the shell, wherein the adoption of such lugs require drilling the shell inevitably interrupting the structural continuity of the shell itself with obvious repercussions on the transmission of sound waves in the same shell.

In addition, the assembly operations of the fastening and tensioning means are labour-consuming.

The task of the present invention is to develop a structure of a percussion musical instrument, such as a drum and the like, capable of overcoming the above-mentioned drawbacks and limitations of the prior art.

Specifically, an object of the invention is to develop a percussion instrument structure that allows to produce different sonorities if compared to the drums of the prior art.

Another object of the invention is to develop a percussion instrument structure on which mounting or replacing a head is simpler and quicker.

The above-mentioned task and objects are achieved by a structure of a percussion musical instrument, such as a drum and the like, according to claims.

Further characteristics of the structure of a percussion musical instrument are also described in the claims.

Furthermore, the object of the invention is to propose a method for producing such a structure of a percussion musical instrument that is simpler, cheaper and easily adaptable to produce percussion musical instruments with different sizes, than the methods proposed by the prior art.

In particular, if compared to the methods of the prior art which provide to make the tubular shell of the percussion musical instrument by a plastic moulding technique, such a production method allows to produce tubular shells with different sizes, particularly with different diameters, through simple procedural changes, rather than having to be equipped with several moulds, each suitable for making a tubular shell of a predefined diameter.

### BRIEF DESCRIPTION OF THE DRAWINGS

The task and the aforesaid objects, together with the advantages that will be mentioned hereinafter, are highlighted by the description of an embodiment of the invention, which is given by way of non-limiting example with reference to the attached drawings, where:

FIG. 1 represents a perspective view of a group of elements of a percussion instrument structure according to the invention;

FIG. 2 represents a perspective view of a component of the group of elements of FIG. 1;

FIG. 3 represents a perspective view of another component of the group of elements of FIG. 1;

FIG. 4 represents a section side view of a portion of a percussion instrument structure according to the invention;

FIG. 5 represents a side view of a portion of a percussion instrument structure according to the invention;

FIG. 6 represents a section view according to the section line VI-VI of FIG. 5;

FIG. 7 represents a section view according to the section line VII-VII of FIG. 5.

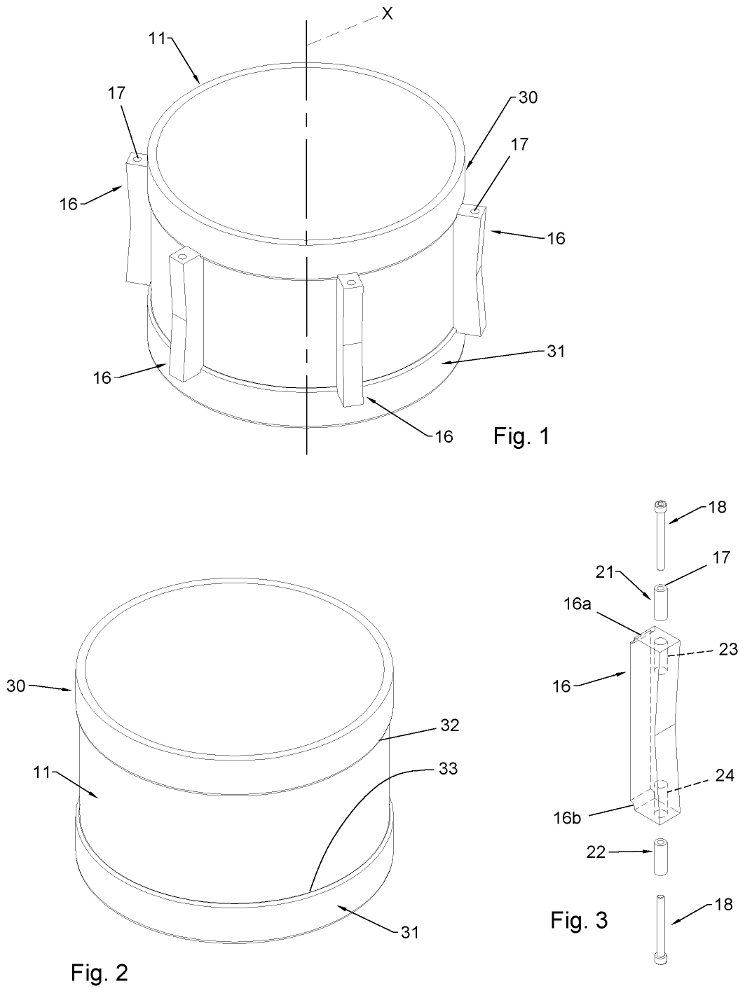

### DETAILED DESCRIPTION OF THE PREFERRED EMBODIMENTS

With reference to the mentioned figures, a structure of a percussion musical instrument according to the invention is indicated as a whole by number 10.

Such a structure of a percussion musical instrument 10, such as a drum, comprises:
a tubular shell 11 having a main axis X of symmetry;
at least one membrane 12, said membrane 12 being attached to a perimeter bearing hoop 13, as schematized in FIG. 3;
a tensioning hoop 14 for said at least one membrane 12, configured to be arranged above said bearing hoop 13 and to be constrained to said tubular shell 11;
fastening and tensioning means 15, configured to constrain the tensioning hoop 14 to the tubular shell 11 in a direction substantially parallel to the main axis X of said tubular shell 11.

The membrane 12 consists of a head, which may in turn be a natural head or a synthetic head or another similar and equivalent membrane.

Such a structure of a percussion musical instrument 10 is characterized by the fact that the tubular shell 11 consists of a single body made of thermoplastic polymeric material.

For example, such a tubular shell 11 made of thermoplastic polymeric material is made of PP, i.e., polypropylene, or PE, i.e., polyethylene, or PVC, i.e., polyvinyl chloride.

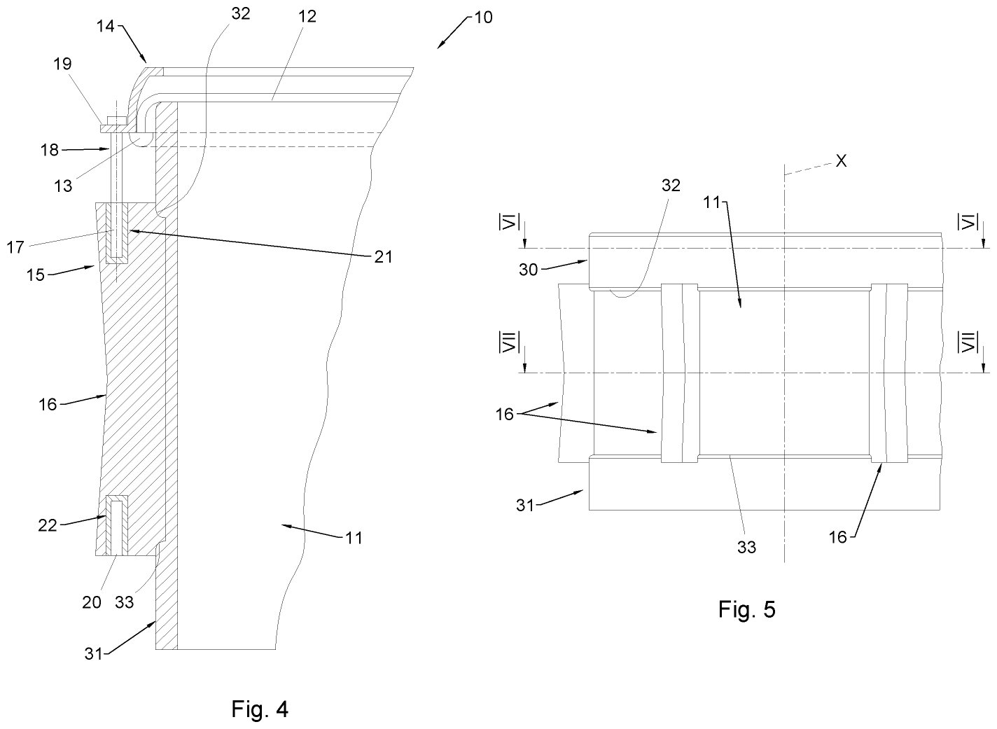

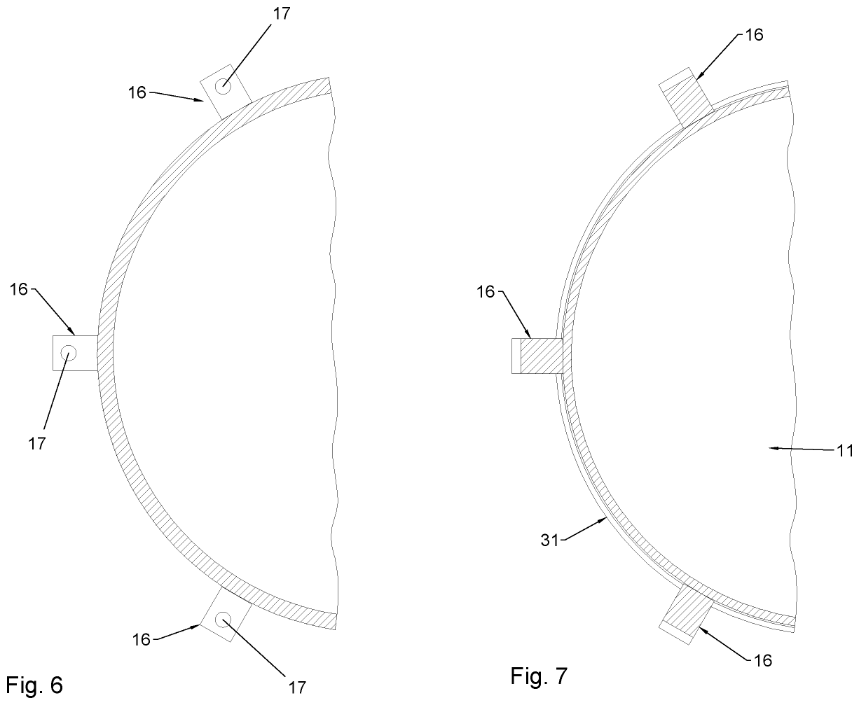

The fastening and tensioning means 15 comprise:
a plurality of screwing lugs 16 each bearing at least one threaded hole 17 extending in a direction substantially parallel to said main axis X;
a screw tension rod 18 for each of the screwing lugs 16;
a perimeter portion 19, schematized in FIG. 4, for each of said screwing lugs 16, such perimeter portions 19 being parts of the tensioning hoop 14; the perimeter portions 19, known in themselves, have a through-hole for a corresponding screw tension rod 18.

The screw tension rods 18 are arranged to pass through the respective through holes on the perimeter portions 19 and to be screwed to the respective screwing lugs 16.

A peculiarity of the invention lies in that each of such screwing lugs 16 is made of thermoplastic polymeric material.

Such screwing lugs 16 made of thermoplastic polymeric material are made of PP, i.e., polypropylene, or PE, i.e., polyethylene, or PVC, i.e., polyvinyl chloride. The screwing lugs 16 are welded to the tubular shell 11.

Specifically, the screwing lugs 16 are welded to the tubular shell 11 by an overlay welding operation, or infra-red, ultrasonic, or poly fusion welding or other similar and equivalent welding techniques.

The tubular shell 11, consisting of thermoplastic polymeric material, and the screwing lugs 16, also made of thermoplastic polymeric material, allow to be mutually fastened by welding, thus without resorting to drilling operations of the tubular shell and subsequent fastening operations by screwing in one or more fastening screws for each screwing lug, as instead is the case for the drums of the known-type.

In the present obviously non-limiting embodiment of the invention, each screwing lug 16 comprises a first upper threaded hole 17 and a second lower threaded hole 20, schematized in the section view of FIG. 4.

Such first upper threaded hole 17 and second lower threaded hole 20 are open in opposite sides of the same direction, so the first upper threaded hole 17 is open upwards and the second lower threaded hole 20 is open downwards.

The terms ‘up’ and ‘down’ refer to the normal attitude in the use of a drum, that is, with the membrane 12 facing upwards available to be struck by a user.

Such first upper threaded hole 17 and second lower threaded hole 20 are basically coaxial according to a direction parallel to said main axis X.

In the embodiment of the invention described herein as a non-limiting example of the invention, each threaded hole 17, 20 is defined by a metal insert 21 and 22 respectively, each of such metal inserts 21 and 22 being fixed within a seat 23, 24 defined on a corresponding screwing lug 16; such seats 23 and 24 are exemplified in FIG. 3.

The metal insert 21 and 22 is externally threaded and is screwed inside its corresponding seat 23 and 24.

The seat 23 and 24 is internally counter-threaded to the outer thread of the corresponding metal insert 21 and 22.

Alternatively, the metal insert 21 and 22 is of the self-threading type, that is, its outer thread grabs directly to the inner surface of the seat 23 and 24 without a thread being already predefined on that inner surface.

Alternatively, the metal insert 21 and 22 is fastened in its seat 23 and 24 by gluing or by other similar and equivalent fastening means to be considered as known.

In the present embodiment, each screwing lug 16 basically consists of a solid body made of thermoplastic polymer material, which solid body mainly extends in a direction parallel to said main axis X.

In such an embodiment, each screwing lug 16 comprises two threaded holes, a first upper threaded hole 17 and a second lower threaded hole 20.

In a variant embodiment of the invention, not shown for ease of simplicity, the fastening and tensioning means comprise a plurality of upper screwing lugs, each comprising only an upper threaded hole, i.e., open upwards.

In another variant embodiment of the invention, the fastening and tensioning means comprise:
a set of upper screwing lugs, each comprising only one upper threaded hole, i.e., open upwards,
and a set of lower screwing lugs, each comprising only one lower threaded hole, i.e., open downwards.

In the present obviously non limiting embodiment of the invention, the tubular shell 11 has at least one outer perimeter relief 30 in correspondence of at least one of its ends.

Such outer perimeter relief 30 is defined, for example, by a relief perimeter annular band.

This outer perimeter relief 30 defines an abutment step 32 against which the screwing lugs 16 rest.

Specifically, in the present obviously non-limiting embodiment of the invention, the tubular shell 11 has two outer perimeter reliefs 30 and 31 at its opposite ends.

Each of such outer perimeter reliefs 30 and 31 is defined, for example, by a relief perimeter annular band.

Each of these outer perimeter reliefs 30 and 31 defines an abutment step 32 and 33 respectively, against which the opposite ends of each screwing lug 16 rest.

Each screwing lug 16 has an upper recess 16a and a lower recess 16b, clearly visible in FIG. 3, each of which is shaped to couple with a corresponding abutment step 32 and 33 of a respective outer perimeter relief 30 and 31.

Such outer perimeter reliefs 30 and 31 can give a better visual impact of the structure of a percussion musical instrument 10, while allowing them to facilitate the correct positioning of the screwing lugs 16 during the steps of welding to the tubular shell 11.

As mentioned earlier, the method of making the aforementioned structure of a percussion musical instrument is also part of the invention.

Specifically, such a method involves preparing a flat sheet of properly shaped thermoplastic polymeric material.

Specifically, such thermoplastic polymeric material can be preferably, but not necessarily, selected from PP, i.e., polypropylene, or PE, i.e., polyethylene, or PVC, i.e., polyvinyl chloride.

The second step of the method involves curving such flat sheet on itself, by means of a calendering technique, so as to define a tubular shape for such sheet.

Advantageously, as mentioned earlier, such a calendering technique for making the tubular shell allows to make tubular shells with different diameters, through simple technical expedients.

In other words, such a calendering technique makes it possible to make the production of the structure of the percussion musical instrument of the invention highly versatile, unlike the moulding techniques provided by the methods of the prior art.

The method involves subsequently welding the adjacent edges of the curved tubular-shaped sheet to each other to define said tubular shell 11. As mentioned earlier, such welding is performed by overlay welding, or infra-red, ultrasonic, or poly fusion welding or other similar and equivalent welding techniques.

Furthermore, the method involves arranging a plurality of the above-mentioned screwing lugs 16 made of thermoplastic polymeric material. Specifically, such thermoplastic polymeric material can be preferably, but not necessarily, selected from PP, i.e., polypropylene, or PE, i.e., polyethylene, or PVC, i.e., polyvinyl chloride.

The method then involves welding the screwing lugs 16 to the outer surface of the tubular shell 11.

In this case also, welding can be of the overlay type, or infra-red, ultrasonic, or poly fusion welding or other similar and equivalent welding techniques.

In order to define the structure of a percussion musical instrument of the invention, the method then involves performing the assembly steps widely described above.

Practically, it has been established that the invention achieves the intended task and objects.

In particular, the invention has developed a percussion instrument structure which allows to produce different sonorities if compared to the drums of the known type; in fact, the adoption of a shell made of heat-sealable polymeric material allows to create a tubular shell with very different and particular dimensions, as well as thicknesses that allow to develop drums capable of producing new and different sonorities if compared to what can be obtained with drums made with traditional techniques.

In addition, the percussion instrument structure according to the invention has no through holes interrupting the continuity of the tubular shell, improving the transmission of acoustic waves in it.

In addition, the invention has developed a percussion instrument structure on which it is easier and quicker to mount or replace a head.

In addition, the invention has developed a percussion instrument structure that is relatively simple to make if compared to a similar percussion instrument with a shell made of wood or metal material, due to the possibility of obtaining a tubular shell by, for example, extruding a tubular profile of plastic material.

Furthermore, the object of proposing a method for making such a structure of a percussion musical instrument that is simpler, cheaper and easily adaptable, for the purpose of producing percussion musical instruments having different sizes, if compared to the methods proposed by the prior art, is also achieved.

In particular, the object of proposing a production method that allows, if compared to the methods of the prior art which provide to make the tubular shell of the percussion musical instrument by plastic moulding technique, to produce tubular shells with different sizes, particularly with different diameters, through simple procedural changes, rather than having to be equipped with several moulds, each suitable for making a tubular shell of a predefined diameter, is achieved.

The invention thus conceived is susceptible of numerous modifications and variations, all of which are within the scope of the inventive concept; moreover, all the details may be replaced by other technically equivalent elements.

In practice, the components and materials used, as well as the dimensions and the contingent shapes, can be any one, as long as they are compatible with the specific use, according to requirements and the prior art.

If the characteristics and techniques mentioned in any claim are followed by reference signs, these reference signs are to be intended for the sole purpose of increasing the intelligibility of the claims and, consequently, such reference signs have no limiting effect on the interpretation of each element identified by way of example by these reference signs.
1. A structure of a percussion musical instrument, such as a drum and the like, comprising:
a tubular shell having a main axis of symmetry (X);
at least one membrane, said membrane being attached to a perimeter bearing hoop;
a tensioning hoop for said at least one membrane, configured to be arranged above said bearing hoop and to be constrained to said tubular shell;
fastening and tensioning means, configured to constrain said tensioning hoop to said tubular shell in a direction substantially parallel to the main axis of said tubular shell,
wherein said tubular shell comprises a single body made of thermoplastic polymeric material.

2. The structure of a percussion musical instrument according to claim 1, wherein said fastening and tensioning means comprise:
a plurality of screwing lugs each bearing at least one threaded hole extending according to a direction substantially parallel to said main axis;
a screw tension rod for each of said screwing lugs;
a perimeter portion for each of said screwing lugs, said perimeter portions being parts of said tensioning hoop, said perimeter portions having a through hole for a corresponding screw tension rod,
each of said screwing lugs being made of thermoplastic polymeric material.

3. The structure of a percussion musical instrument according to claim 1, wherein said screwing lugs are welded to said tubular shell.

4. The structure of a percussion musical instrument according to claim 2, wherein each screwing lug comprises a first upper threaded hole and a second lower threaded hole, said first upper threaded hole and second lower threaded hole being substantially coaxial according to a direction parallel to said main axis (X).

5. The structure of a percussion musical instrument according to claim 4, wherein each threaded hole is defined by a metal insert attached within a seat defined on a corresponding screwing lug.

6. The structure of a percussion musical instrument according to claim 1, wherein said metal insert is externally threaded and is screwed inside said seat thereof.

7. The structure of a percussion musical instrument according to claim 2, wherein each screwing lug substantially consists of a solid body made of thermoplastic polymeric material mainly extending in a direction parallel to said main axis (X).

8. The structure of a percussion musical instrument according to claim 1, wherein said tubular shell has at least one outer perimeter relief in correspondence of at least one of its ends.

9. The structure of a percussion musical instrument according to claim 1, wherein said tubular shell made of thermoplastic polymeric material is made of polypropylene or polyethylene or PVC.

10. The structure of a percussion musical instrument according to claim 1, wherein said screwing lugs made of thermoplastic polymeric material are made of polypropylene or polyethylene or PVC.

11. A method for making a structure of a percussion musical instrument according to claim 1, wherein it involves the following steps:
arranging a flat sheet of suitably shaped thermoplastic polymeric material;
curving said flat sheet on itself, by a calendering technique, so as to define a tubular shape for said sheet; and
welding the adjacent edges of said tubular-shaped curved sheet to each other so as to define said tubular shell.

12. (canceled)
